(19) United States
(12) Patent Application Publication
(10) Pub. No.: US 2013/0032742 A1
(43) Pub. Date: Feb. 7, 2013

(54) ELECTROMAGNET WITH ADJUSTING SCREW

(71) Applicants: Georg Scherer, Kirchheim (DE); Helmut Mang, Memmingen (DE); Florian Schreiber, Kadeltshofen (DE)

(72) Inventors: Georg Scherer, Kirchheim (DE); Helmut Mang, Memmingen (DE); Florian Schreiber, Kadeltshofen (DE)

(73) Assignee: FIRMA SVM SCHULTZ VERWALTUNGS-GMBH & CO. KG, Memmingen (DE)

(21) Appl. No.: 13/481,152

(22) Filed: May 25, 2012

(30) Foreign Application Priority Data
May 27, 2011 (DE) 10 2011 103 845.4

(51) Int. Cl. H01F 7/126; F16K 31/02; H01F 41/00

(52) U.S. Cl. 251/129.15; 335/261; 29/602.1

(57) ABSTRACT

The invention refers to a solenoid with a coil that can be supplied with current, an armature supported movably in an armature housing that can be moved by a magnetic field resulting from supplying the coil with current, a magnetic yoke, an armature spring and an adjustment pin that can be inserted in the magnetic yoke, wherein the armature spring is supported, on the one hand, on the adjustment spring, and, on the other hand, on the armature, and the characteristic line of the solenoid can be adjusted through penetration depth of the adjustment pin in the magnetic yoke or the solenoid.

### BACKGROUND OF THE INVENTION

The invention refers to a solenoid with a coil, a magnetic yoke, an armature housing, an armature supported movably in the armature housing, an armature spring and an adjustment pin that can be put in the magnetic yoke.

Solenoids of this kind are often part of a complex operating device. By means of the solenoid, different conditions of the operative device are set, for example a locking is generated or a pressure valve or pressure control valve is operated. The solenoid has a coil that can be supplied with current. When current flows through, the result is a magnetic field acting usually against the power of an (armature) spring on a magnetizable armature that is arranged movably in the armature housing of the solenoid. The armature moves depending on the resulting magnetic field.

So-called proportional magnets or proportional solenoids have been known as well, where the position of the armature (and thus also the position of the element moved by the armature) is proportional or largely proportional to the flow of current.

This results in a movement of the armature between two or more different positions. Generally, the armature acts on an operating element of the solenoid, for example an armature rod or the like. Depending on the arrangement, the operating element is here connected rigidly with the armature, or the armature acts in an appropriate way on a separate operating element, arranged movably in relation to the armature. This operating element can be used, for example, in a pressure control for operating locking elements provided therein, and for mutually connecting the respective feeds or returns or consumer connections to one another. Also the volume flow can be regulated thus.

What is decisive for the proper function and desired effect of the solenoid is the adjustment of a characteristic line. Adjusting the characteristic line is executed through an adjustment pin arranged in the solenoid. The adjustment pin is pressed in the magnet until the eventual adjustment of the desired characteristic line, and acts here as stop for the armature spring, that is supported on the adjustment pin, the spring acting on the armature. Depending on the penetration depth of the adjustment pin in the solenoid or the magnetic yoke provided therein, the spring is compressed and the armature position is adjusted, respectively. Through this, then the armature can be adjusted in the armature housing.

Usually, the adjustment pin is manufactured in a complex process. A cone is screwed on a grinded round rod, the area worked in this way is then cut off or parted from the grinded rod, and, after that, a backside bore hole is integrated in the separated section of the round rod. The procedure described before requires a multiple moving of the component to be worked, so that the manufacturing of the adjustment pin is particularly complex. The result is high costs for the adjustment pin, that is generally a mass product, as suitable solenoids cannot be produced without adjustment pins of this type.

### Short Abstract of the Invention

It is an object of the present invention to improve the state of the art such that a solenoid can be produced with reduced effort and reduced costs.

In order to solve this problem, the invention refers to a solenoid as described in the beginning, and suggest that in the solenoid an adjustment pin is used that can be shaped by means of cold forming of solid material.

Based on the application, for example, of a cold massive forming process for manufacturing the adjustment pin, the before described single, expensive and complex steps for manufacturing the adjustment pin are substituted in conventional metal-cutting processes, and the adjustment pin can be manufactured in a single processing step. During the manufacturing process, a raw part is put in a tool suitable for forming, and is formed without the raw part being heated. Such a forming can be performed by pressing a tool into the raw part. Here in a (single) processing step the shoulder for supporting the armature spring, on the one hand, and the backside recess in the adjustment pin, on the other hand, can be formed. The material weakness or reduction of material thickness in the circumference area of the adjustment pin, that can also be accomplished by forming, eventually achieves the same result, as the boring employed in the conventional procedure.

The adjustment pin manufactured in the cold massive forming process thus can also be inserted in the press fit in a yoke or in another way in the solenoid, and is held in the press fit.

The invention also comprises the use of an adjustment pin manufactured in a cold forming process in a solenoid, in particular in a solenoid as described before. The dimensional accuracy of an adjustment pin manufactured by cold forming may be slightly less than by a metal-cutting machining, however, these increased dimension tolerances are compensated in the adjustment process of the characteristic line, that will take place in any case, as the position of the adjustment pin in the press fit is determined according to the course of the characteristic line and not according to the absolute position of the adjustment pin in the press fit. Surprisingly, therefore a simply manufactured, generally not highly accurate component does not lead the technical properties of the solenoid according to the invention to deteriorate, so that in particular the use according to the invention is advantageous.

It is an essential advantage of the invention that the adjustment pin can be provided economically. Furthermore, the use of a pressing tool for forming guarantees that the manufactured adjustment pins have always constant quality and dimensions.

Cleverly, the projection has a smaller diameter than the rest of the adjustment pin. Seen in direction of assembly, the projection is put in first in the opening or yoke or the solenoid forming the press fit, and the smaller diameter makes, of course, inserting the adjustment pin in the press fit easier.

The projection forms a mandrel on which the armature spring can be slid. The projection thus serves also for guiding and centering the armature spring.

A preferred embodiment provides between the cylindrical section and the projection a fitting shoulder, in particular for the armature spring. Cleverly, the projection is configured here as radially circulating annular surface, however, it can also be cone-like or inclined funnel-like.

It is an advantage that the shaping of the recess, the forming of the projection as well as of the fitting shoulder is performed in a single step of the cold forming, in particular relating to a raw part designed as section of a profile or rod. Clever configuration of the cold forming tool allows performing all necessary forming operations in the raw part in a single processing step, what saves time and costs.

Another improvement provides that between the projection and the cylindrical section, in particular between the fitting shoulder and the cylindrical section, in particular a cone is provided, that is integrated, preferably also during the single cold forming processing step, in the adjustment pin. The before mentioned cone precedes the cylindrical section in assembly direction, and thus makes inserting the cylindrical section in the press fit easier. The press fitting occurs in the cylindrical section and the (insertion) cone, arranged before in assembly direction, makes mounting easier.

The solenoid suggested according to the invention is employed preferably in a pressure control valve, and here in particular in a proportional pressure control valve. In a proportional pressure control valve, the pressure is related, at least in certain areas, in a proportional relation with a control value, for example current of the electricity flowing through the coil of the solenoid. Cleverly, therefore the solenoid is configured as proportional solenoid, and has, at least in sections, a corresponding proportionality or other course of the characteristic line, as desired. Just for being able to set this course of the characteristic line, the adjustment pin suggested according to the invention is provided.

The solenoid according to the invention is suited in particular for the use in a pressure control valve, also provided according to the invention. Here, the armature operated via the armature spring and the electro-magnetic electrification of the coil is connected with an activation rod that acts on the locking elements of the valve part and moves them from a first in a second locking position. The adjustment of the characteristic line of the pressure control valve is performed here through the adjustment pin, that is pushed, until the perfect characteristic line has been reached that is determined in a testing process, in the solenoid or the yoke bridging the solenoid. The armature spring is compressed, and thus the armature in the armature housing is shifted. This again can adjust the effect on the locking parts of the pressure control valve.

In this connection it is, in particular, pointed out that all characteristics and features described with reference to the solenoid, but also methods, can be transferred and used in a solenoid accordingly also with reference to the formulation of the use according to the invention of an adjustment pin, manufactured in a cold forming process, and are seen also as disclosed. The same goes also vice versa, that means constructive, i. e. device characteristics mentioned only with reference to the use, can also be considered and claimed in the frame of claims for the solenoid, and are also part of the invention and disclosure.

### BRIEF DESCRIPTION OF THE DIFFERENT VIEWS OF THE DRAWINGS

In the drawing the invention is shown schematically in particular in an example. In the FIGS.:

FIG. 1 a pressure control valve in lateral sectional representation with solenoid according to the invention,

FIG. 2 the adjustment pin in sectional view according to the invention.

In the FIGS. identical or corresponding elements each are indicated by the same reference numbers, and therefore are, if not useful, not described anew.

### DETAILED DESCRIPTION OF THE PREFERRED EMBODIMENT

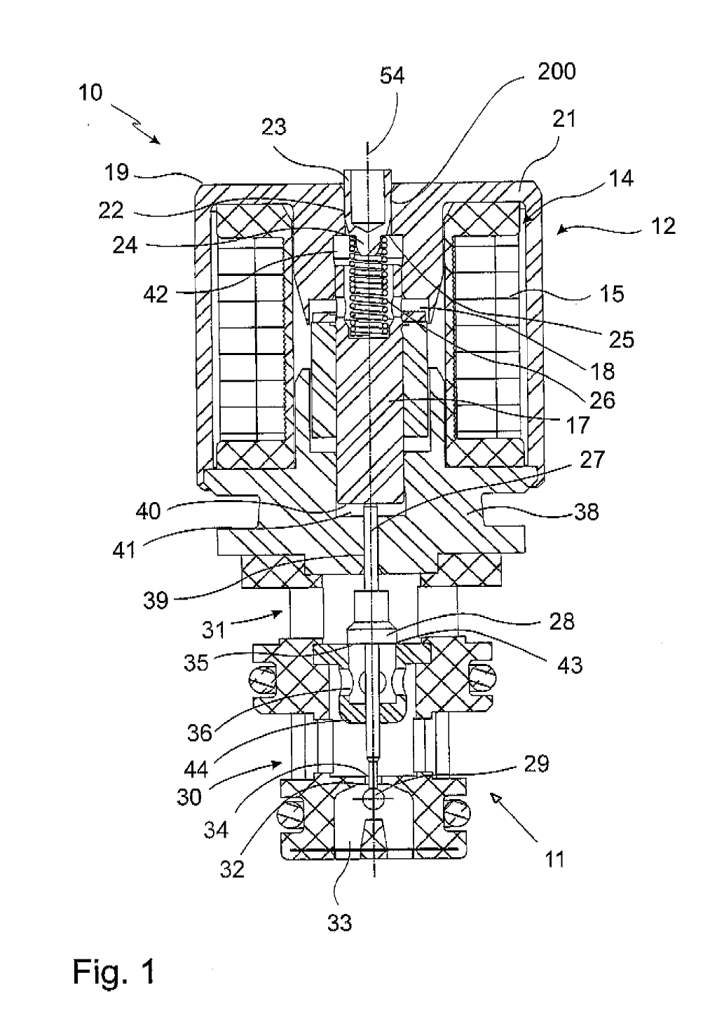

FIG. 1 shows an optional embodiment of an electro-magnetic pressure control valve 10, consisting of a valve part 11 and a magnetic part 12 arranged coaxially thereto. The magnetic part 12 has a coil body with a coil 15. In the coil body 14 an armature 17 is supported movably in an armature housing 18. On the upper side 19 of the magnetic part 12 a (not shown) connector housing is linked through which the coil 15 can be supplied with current. In the yoke 21 of the magnetic part 12 a recess 22 is located in which an adjustment pin 23 is inserted. The yoke 21 rests on the side of the armature 17 opposite the valve part 11. Thus also the adjustment pin 23 and the armature spring 26 are located on the side of the armature 17 opposite the valve part 11. The adjustment pin 23 is held in a recess 22 in a press fit 200. The adjustment pin 23 has a projecting nose 24, besides, the adjustment pin 23 has a shoulder 25 supporting an armature spring 26. On its opposite end, the armature spring 26 is supported on the armature 17. For adjustment purposes, the adjustment pin 23 is movable in direction of the movement of the armature 17 in the press fit 200, wherein, of course, sufficient power has to be applied to overcome the holding forces in the press fit 200. These holding forces are, of courses, quite some more than the axial forces of the armature spring 26 usually occurring during operation of the solenoid.

When the coil 15 is supplied with current, the armature 17 is shifted against the spring power of the armature spring 26 in the armature housing 18. When the electrifying of the coil 15 ends, the armature spring 26 guides the armature 17 back in the starting position. The armature 17 has an activation rod 27 connected with the first locking part 28 of the valve part 11. In the embodiment of the pressure control valve 10 shown in FIG. 1, this is presented in a first resting position. The first locking part 28 locks here a passage opening in the valve part 11. In the second, lower part 30 of the valve part 11 connected with the center part 31 through a screw connection, a valve seat 32 for a second locking part 29 is provided. The activation rod 27 of the armature 17 continues after the first locking part 28 in axial direction of the electro-magnetic pressure control valve 10, and forms here a tappet acting on the second locking part 29. When the coil 15 is supplied with current, the armature 17 is moved out of the position shown in FIG. 1 against the spring force of the armature spring 26, and lifts the tappet from the second locking part 29. Because of the medium flowing in through the feed opening 33, the second locking part 29 is pressed in the valve seat 35 and thus the opening 34 is sealed, i. e. the medium flow is separated. The movement of the armature 17 lifts the first locking part 28 out of the valve seat 35 and thus releases the passage.

The medium flowing in the lower valve part 30 can only flow through bore holes 36 in a cage 44 linked below the first valve seat 35 in the opening 43 released by the locking part 28 lifted from the valve part. The pressure control valve works according to the pressure dividing principle, wherein the actual pressure control is performed at the first seat valve (formed by the first locking part 28 and the first valve part 35). The second (first with reference to the direction of medium flow) seat valve (formed by the second locking part 29 and the second valve seat 32) is opened.

Directly below the coil 15 the core 38 of the solenoid is joined having a passage bore hole 39 through which the activation rod 27 is guided. Between the lower end 40 of the armature facing the valve part 11 and the core 38, a working gap 41 exists in axial direction.

Another working gap 42 exists between the end of the armature 17 facing the yoke 21 and the yoke. In the non-electrified resting position of the magnetic part 12 this gap 42 is opened.

The armature spring 26 is supported, on the one hand, on a shoulder 25 provided at the adjustment pin 23, on the other hand, on the armature 17. For a more stable support of the armature spring 26, the adjustment pin 23 has a projecting nose or a projection 24 that is partly encircled by the windings of the armature spring 26. The second, free end of the armature spring 26 is supported on a supporting surface provided in the armature 17 thereon.

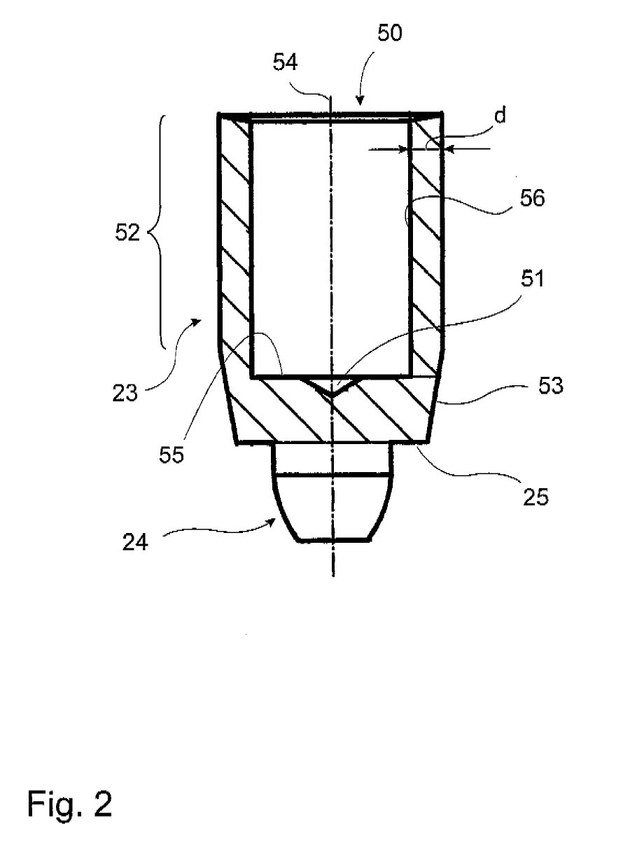

FIG. 2 shows an optional configuration of the adjustment pin 23. This has been shaped in a cold massive forming process from a work piece raw part. This is, for example, a section of a profile or rod with a preferable round cross section, of metal, wherein for example iron, steel or aluminum can be employed here.

A suitable pressing tool serves for this. A punch acts here on the raw work piece in such a way that it is formed. The tool is here configured such that during forming the nose-like projection 24 is shaped in longitudinal direction (or in axial direction, defined by the center axis 54 of the adjustment pin 23 that is preferably essentially parallel to the direction of movement of the armature 17) in the raw part. The raw part is pressed for this by the punch of the pressing tool in a corresponding die. The center axis 54 is orientated parallel to the direction of movement of the armature 17 and the direction of movement of the adjustment pin 23 in the press fit 200. During forming, also the recess 50 is shaped in the adjustment pin 23. The recess 50 is here located on the side opposite the projection 24. The recess 50 extends at least in the cylindrical area 52 of the adjustment pin 23. At least some parts of the cylindrical area 52 form essentially the surface area of the adjustment pin 23 effecting a sufficiently mechanically solid connection in the recess 22 of the yoke 21 in the press fit 200.

Based on the reduction of the wall thickness d of the adjustment pin occurring in the area of the recess 50 during the cold forming, this part of the adjustment pin 23 can be formed to a limited degree what favors inserting in a corresponding recess 22 in the yoke 21 of a solenoid. The adjustment pin 23 can be held here in the press fit 200.

Additionally, the adjustment pin 23 has a fitting shoulder or shoulder 25 on which the armature spring 26 can be supported. The nose-like projection 24 or nipple projects here partly in the armature spring 26. This stabilizes the position of the armature spring 26 in the solenoid. The shoulder 25 is designed here as flange-like annular surface. It extends, seen in direction of the center axis 54 after the cylindrical area 52 and the insertion cone 53, before the projection 24. The conical shape of the nipple 24 is here a result of the tool used for manufacturing the adjustment pin 23. Besides the conical or truncated conical configuration presented here, there is, of course, also the option of designing the projection 24 or nipple in the way of a cylinder or also cone-like, ball-like or spherically (e. g. differing from a ball shape).

The recess 50 is not formed by metal-cutting, but by (cold) forming. It is configured in longitudinal direction of the center axis 54, preferably coaxially thereto, as pocket hole.

In the interior of the recess 50, on the bottom 55 of the pocket hole, a cone-like embossed stamp 51 can be discerned. This is also a result of the forming process. This indentation or depression serves also for receiving the tool that is used for inserting or impressing the adjustment pin 23 in the solenoid or its yoke 21. The indentation or depression prevents here effectively a sliding or shifting of the tool in the adjustment pin 23. As a rule, the tool has a diameter smaller than the diameter of the recess 50 in order to favor here the elastic forming of the adjustment pin 23 during the impressing process in the solenoid.

The interior walls or surface area 56 of the recess 50 can be weakened specifically in certain areas by the (cold) forming process, for example by a groove or flute extending parallel to the center axis 54, in order to configure thus the cylindrical section 52 “softer” for impressing in the press fit 200.

Inserting the adjustment pin 23 in the solenoid or in a recess 22 provided there is improved additionally by the conical tapering of the outside walls of the adjustment pin 23 in the area between the cylindrical section 52 and the shoulder 25. Based on the thus reduced diameter, the adjustment pin 23 can be inserted particularly easily in the recess 22. The chamfer or the cone 53 thus serves for guiding the adjustment pin 23. Its length changes because of the cold forming of a raw work piece. At the same time, the material thickness is increased in the area of the nipple 24 or the joining lower area of the adjustment pin 23.

The adjustment pin 23 shown in FIG. 2 can be manufactured in a single processing step. The metal-cutting preparation of a raw work piece, for example a round rod or other cylindrical blank, and the following applying of a bore hole on the back side is deleted. Instead, the recess 50 is manufactured in one processing step along with the nipple 24 or projection or diameter-reduced extension, so that the costs for the adjustment pin 23 can be reduced altogether. Lower costs for the adjustment pin reduce the costs altogether for manufacturing a solenoid equipped with the adjustment pin 23. As material for manufacturing the adjustment pin all materials suited for cold massive forming are suitable, such as, for example, low alloy steels and several non-iron metals, in particular aluminum and copper.

Compared with the hot massive forming or a metal-cutting or milling machining of the adjustment pin 23, the form and dimensional accuracy of the cold formed adjustment pins 23 is essentially larger. There is no shrinkage during cooling. There are none or only little tolerances, compared with the metal-cutting machining with this type of material forming. As the material forming the adjustment pin 23 solidifies during pressing, when cold, in the cold massive forming, for example high alloy steels can be substituted by more economic materials.

The stress distribution in the adjustment pin 23 can be controlled easily because of the rotational symmetric shape. Based on the mere forming of the material, the result is, in contrast to metal-cutting processes employed conventionally for manufacturing the adjustment pin 23, a rather high saving of material and, additionally a saving of machining time described already before, as by pressing an essentially higher machining time is reached. The consequent machining, for example finishing of the surface or the like, is also deleted because of the forming process with only one processing step.

During the massive forming, a raw work piece is formed between a punch and a die with considerably pressure, and thus the material forming the blank is forced to flow in the free space between punch and die. For manufacturing the adjustment pin shown in FIG. 2, the die has a hollow space tapering pot-like. In this pot-like tapering the nipple 24 forms in the course of the forming process as the material displaced during pressing flows in this pot-like recess of the die. At the same time, the rest of the material flows in the hollow space between the inside of the die and the punch pressed on the raw work piece, so that here a material tapering occurs and thus the circumferential wall of the adjustment pin 23 is formed. This reduces the wall thickness d and thus the material thickness of the work piece, however, lengthens the length of the adjustment pin 23 altogether.

Although the invention has been described in terms of specific embodiments which are set forth in considerable detail, it should be understood that this is by way of illustration only and that the invention is not necessarily limited thereto, as alternative embodiments and operating techniques will become apparent to those skilled in the art in view of the disclosure. Accordingly, modifications are contemplated which can be made without departing from the spirit of the described invention.

1. Solenoid with a coil that can be supplied with current comprising:
an armature supported mobile in an armature housing that is movable through a magnetic field resulting from the coil being supplied with current, a magnetic yoke:
an armature spring; and
an adjustment pin that can be put in the magnetic yoke, wherein the armature spring is supported, on one side, on the adjustment pin and, on another side, on the armature, and the characteristic line of the solenoid can be set via the penetration depth of the adjustment pin in the magnetic yoke or the solenoid, wherein as adjustment pin a component is provided that is shaped by cold forming.

2. Solenoid according to claim 1, wherein the adjustment pin is based on a raw part that is at least one of a section of a profile or rod, and includes a projection that can be formed during the cold forming step and extends, in particular, in longitudinal direction of the adjustment pin.

3. Solenoid according to claim 1, wherein the adjustment pin is based on a raw part, that is at least one of a section of a profile or rod, and includes a projection that can be formed during the cold forming step and extends in longitudinal direction of the adjustment pin, and wherein the projection has a smaller diameter than a remaining portion of the adjustment pin.

4. Solenoid according to claim 1, wherein the adjustment pin based on a raw part and includes at least one of a section of a profile or rod, and includes a projection that can be formed during the cold forming step and extends in longitudinal direction of the adjustment pin, and wherein the projection is designed cone-like, truncated cone-like, nipple-like, ball-like, spherical or cylindrical.

5. Solenoid according to claim 1, wherein the adjustment pin based on a raw part and includes at least one of a section of a profile or rod, and includes a projection that can be formed during the cold forming step and extends in longitudinal direction of the adjustment pin, and wherein the projection serves for guiding and centering, respectively, of the armature spring.

6. Solenoid according to claim 1, wherein the adjustment pin is based on a raw part and includes at least one of a section of a profile or rod, and includes a projection that can be formed during the cold forming step and extends in longitudinal direction of the adjustment pin, and wherein the adjustment pin defines, on a side opposite the projection, a recess configured as pocket hole.

7. Solenoid according to claim 1, wherein the adjustment pin based on a raw part and includes at least one of a section of a profile or rod has and includes a projection that can be formed during the cold forming step and extends in longitudinal direction of the adjustment pin, and wherein the adjustment pin defines, on a side opposite the projection* a recess configured as pocket hole, and wherein at least in an area of the recess a cylindrical section is located at the adjustment pin, and the adjustment pin has a material weakness of a wall thickness of the wall limiting the recess formed during the cold forming.

8. Solenoid according to claim 1, wherein the adjustment pin based on a raw part and includes at least one of a section of a profile or 3 rod and includes a projection that can be formed during the cold forming step and extends in longitudinal direction of the adjustment pin, and wherein the adjustment pin defines, on a side opposite the projection., a recess configured as a pocket hole, and wherein at least in an area of the recess a cylindrical section is located at the adjustment pin, and the adjustment pin has a material weakness of a wall thickness of the wall limiting the recess occurred during the cold forming, and wherein between the cylindrical section and the projection a fitting shoulder is provided for the armature spring.

9. Solenoid according to claim 1, wherein the adjustment pin based on a raw part and includes at least one of a section of a profile or a rod and includes a projection that can be formed during the cold forming step and extends in longitudinal direction of the adjustment pin, and wherein the adjustment pin defines, on a side opposite the projection, a recess configured as a pocket hole, and wherein a molding of the recess, the projection as and a fitting shoulder are formed in a single process step of the cold forming.

10. Solenoid according to claim 1, wherein the adjustment pin based on a raw part and includes at least one of a section of a profile or rod and includes a projection that can be formed during the cold forming step and extends in longitudinal direction of the adjustment pin, and wherein the projection serves for guiding and centering, respectively, of the armature spring, and wherein between the projection and the cylindrical section, in particular between a fitting shoulder and the cylindrical section, a tapering section is provided, that is molded.

11. Solenoid according to claim 1, wherein the solenoid is configured as proportional solenoid.

12. A method for manufacturing a solenoid comprising the steps of: manufacturing a solenoid in a cold forming process; and
using an adjustment pin in the step of manufacturing.

13. The method according to claim 12, wherein the adjustment pin is set in a press fit of the solenoid, and further comprising changing a position of the characteristic line of the solenoid with the adjustment pin.

14. Pressure control valve having the solenoid, according to claim 1 including a valve part, that includes at least one passage opening constructed and arranged to be closed or opened by a closing part, wherein the closing part is in operative connection with the armature of the solenoid.

15. Pressure control valve having the solenoid, according to claim 2 including a valve part, that includes at least one passage opening constructed and arranged to be closed or opened by a closing part, wherein the closing part is in operative connection with the armature of the solenoid.

16. Pressure control valve having the solenoid, according to claim 3 including a valve part, that includes at least one passage opening constructed and arranged to be closed or opened by a closing part, wherein the closing part is in operative connection with the armature of the solenoid.

17. Pressure control valve having the solenoid, according to claim 4 including a valve part, that includes at least one passage opening constructed and arranged to be closed or opened by a closing part, wherein the closing part is in operative connection with the armature of the solenoid.

18. Pressure control valve having the solenoid, according to claim 5 including a valve part, that includes at least one passage opening constructed and arranged to be closed or opened by a closing part, wherein the closing part is in operative connection with the armature of the solenoid.

19. Pressure control valve having the solenoid, according to claim 6 including a valve part, that includes at least one passage opening constructed and arranged to be closed or opened by a closing part, wherein the closing part is in operative connection with the armature of the solenoid.

20. Pressure control valve having the solenoid, according to claim 11 including a valve part, that includes at least one passage opening constructed and arranged to be closed or opened by a closing part, wherein the closing part is in operative connection with the armature of the solenoid.
